(19) United States
(12) Patent Application Publication
(10) Pub. No.: US 2011/0220030 A1
(43) Pub. Date: Sep. 15, 2011

(54) Connector for Receptacle

(75) Inventor: Murat Akyuz, Istanbul (TR)

(73) Assignee: Ugo Petcare LLC, Cardiff, CA (US)

(21) Appl. No.: 13/017,038

(22) Filed: Jan. 30, 2011

Related U.S. Application Data
(60) Provisional application No. 61/313,123, filed on Mar. 12, 2010.

(51) Int. Cl. A01K 29/00; F16B 2/00

(52) U.S. Cl. 119/165; 403/300

(57) ABSTRACT

A connector for connecting multiple receptacles is provided. The connector has at least one midline support having a base at its bottom end, wherein the base comprises a left flange and a right flange, and wherein the right flange has a lip extending in an upward direction from its end, and the left flange has a lip extending in an upward direction from its end. A right side of the midline support, the right flange and right lip form a right channel at the base, and a left side of the midline support, left flange and left lip for a left channel at the base. The connector also has a top cover at the top of the midline support, wherein the top cover extends laterally in both the left and the right directions from the midline support.

The application claims priority from U.S. Provisional Patent Application No. 61/313123, filed Mar. 12, 2010, the entirety of which is incorporated herein by reference.

### FIELD OF THE INVENTION

The present invention relates generally to connectors for connecting multiple receptacles, such as multiple dog potties in a manner that prevents leakage of fluid between any gaps or spaces that may exist between the multiple receptacle. The present invention also relates generally to connectors for connecting multiple receptacles, such as multiple dog potties in a manner that prohibits or prevents dogs or other pets from disconnecting the multiple receptacles from one another.

### BACKGROUND OF THE INVENTION

Dog potties are already known in the art. Examples of such dog potties include the UGODOG®, which is a dog potty that can be used indoors or outdoors. They typically come in one size. The size is practical for most breeds of dogs, but there are very large breed dogs that would benefit from larger dog potties that don't exist. One example of a dog potty is described in U.S. application Ser. No. 11/972,094, filed Jan. 10, 2008, which is incorporated herein by reference in its entirety.

Some people place two dog potties next to each other to make enough space for their large breed dogs. The problem with this approach is that if the dog urinates over the seem that exists between the two dog potties, then the urine leaks through the seem space and onto the floor. Another problem that this creates is that there is no practical way to keep the dog potties right next to each other, and dogs often move them around either accidentally or intentionally thus opening the gap between the two dog potties.

Thus, what is needed is a connector for receptacles, such dog potties that prevents leakage of fluid between any gaps or spaces that may exist between multiple receptacles. The receptacle must also solve the problem of preventing or prohibiting dogs or other pets from disconnecting the multiple receptacles from one another, while being easy for human handlers to disconnect the multiple receptacles from one another.

### SUMMARY OF THE INVENTION

In one particularly innovative aspect, a connector for connecting multiple receptacles is provided. The connector has at least one midline support having a base at its bottom end, wherein the base comprises a left flange and a right flange, and wherein the right flange has a lip extending in an upward direction from its end, and the left flange has a lip extending in an upward direction from its end. A right side of the midline support, the right flange and right lip form a right channel at the base, and a left side of the midline support, left flange and left lip for a left channel at the base. The connector also has a top cover at the top of the midline support, wherein the top cover extends laterally in both the left and the right directions from the midline support.

In another aspect, a dog potty system is provided. The dog potty system has a first dog potty and a second dog potty. The first dog potty has a perimeter with four walls and a receptacle that catches and retains fluid, wherein each of the walls has a top side and a bottom side. The second dog potty has a perimeter with four walls and a receptacle that catches and retains fluid. One of the walls of the first dog potty is adjacent one of the walls of the second dog potty. The dog potty system also has a connector that connects the first and second dog potties. The connector has a length that is approximately the same length or shorter than the length of the walls of the dog potties that are adjacent to one another. The connector has a top cover having a top side and a bottom side, wherein the top cover covers the top sides of the walls of the adjacent dog potties and channels any fluid into the receptacles of the first and second dog potties. The connector also has a midline support that extends downward from the bottom side of the top cover, wherein the midline support has a bottom end that has a first channel and a second channel. The first channel receives the bottom side of the wall of the first dog potty that is adjacent to the wall of the second dog potty, and the second channel receives the bottom side of the wall of the second dog potty that is adjacent to the wall of the first dog potty, such that the two dog potties are horizontally connected to one another by the connector.

Other objects and features of the present invention will become apparent from consideration of the following description taken in conjunction with the accompanying drawings.

### BRIEF DESCRIPTION OF THE DRAWINGS

FIG. 1A is a three-dimensional perspective view of a receptacle connector.

FIG. 1B is a three-dimensional perspective view of a receptacle connector of another embodiment.

FIG. 1C is a three-dimensional perspective view of a receptacle connector of another embodiment.

FIG. 1D is a three-dimensional perspective view of a receptacle connector of another embodiment.

FIG. 1E is a three-dimensional perspective view of a receptacle connector of another embodiment.

FIG. 2 is a cross-sectional view of the receptacle connector of FIG. 1

FIG. 3 is a three-dimensional perspective view of the receptacle connector of FIG. 1 connecting two dog potties.

FIG. 4 is a cross-sectional view through lines 4-4 of FIG. 3.

FIG. 5 is a three-dimensional perspective view of a receptacle connector of another embodiment.

### DESCRIPTION OF PREFERRED EMBODIMENTS

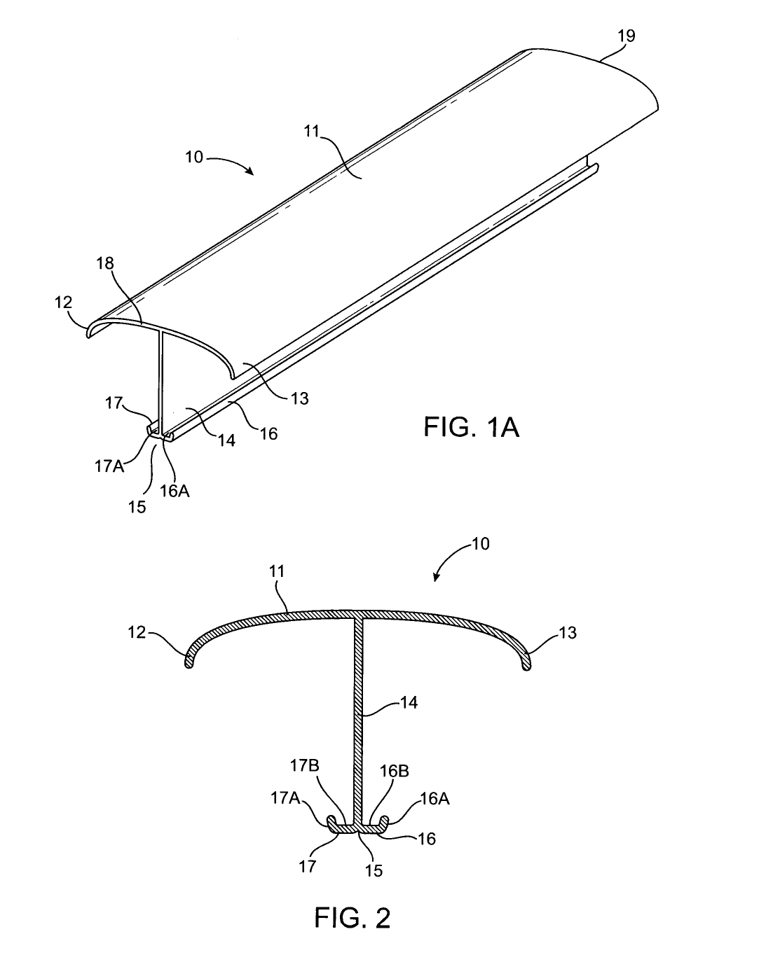

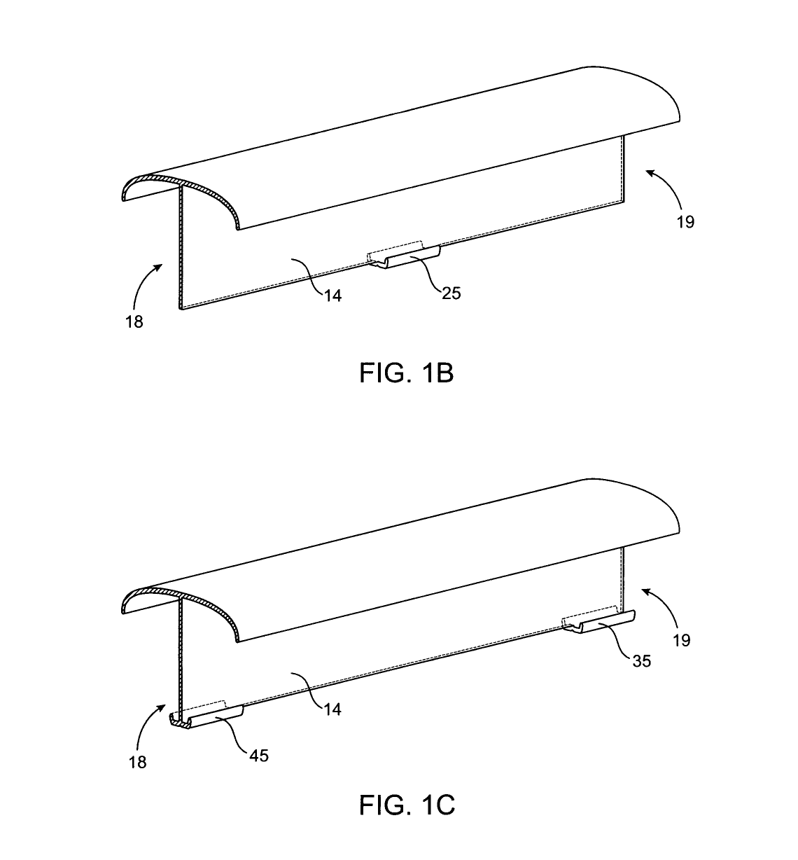

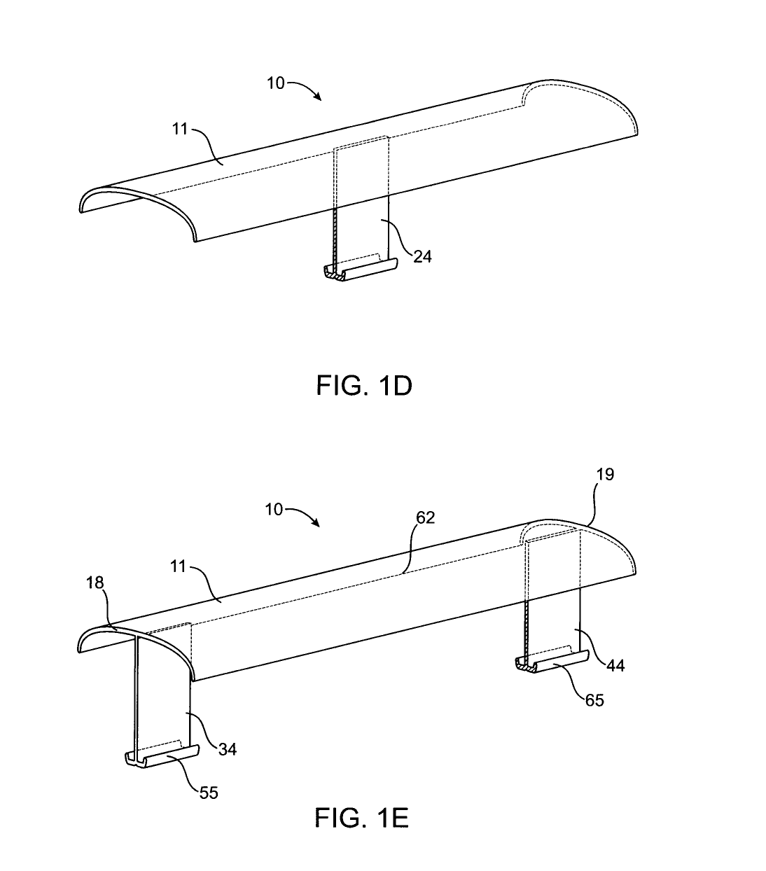

Turning now to the drawings, FIGS. 1A and 2 show a first embodiment of a connector 10 for connecting multiple receptacles. The connector 10 can be made of a unibody construction, or can be made of various parts that are connected together gluing, fusing, soldering, screwing, nailing, and through various other means known in the art. In one embodiment, the connector 10 is made of a unibody construction from a single mold.

The connector 10 can be made of various materials, such as plastic, various metals, wood, or various composite materials. In one embodiment, the connector 10 can be made of polypropylene or other plastic raw material.

The connector can be of various lengths from one end 18 to the other end 19. Its length will depend on the length of the sides of the receptacle that it connects. In one example, the connector can be between about 1 and about 50 inches long, or between about 5 and about 30 inches long, or between about 10 and about 25 inches long, or between about 12 and 25 inches long, or between about 15 and about 25 inches long, or between about 20 and about 25 inches long, or between about 20 and about 30 inches long. In one embodiment, it is about 25 inches long from one end 18 to the other end 19.

The connector is formed by two members that can be integrally formed with one another or connected to one another as described above. The first member is a top cover 11 that in one embodiment is shaped like a tudor arch. The second member is a midline support 14 (sometimes referred to as a web, as in the web of an I-beam).

The top cover 11 covers the gap between two receptables. The top cover 11 spans the entire length of the connector 10. The top cover 11 has a right haunch 13 and a left haunch 12 that give the cover its tudor arch shape. The top cover 11 should extend most of the length of the sides of the receptacle that it is used to connect. Thus, for example, if a receptacle has a connection side that is about 26 inches in length, the top cover 11 can be about 24 or 25 inches in length. In one embodiment, the connector is about 24.25 inches in length.

The midline support or web 14 extends vertically downward from the bottom side of the top cover 11. The junction between the midline support and the bottom of the top cover 11 forms about a ninety degree angle, such as in an I-beam. The top of the midline support 14 is at the bottom side of the center or apex of the arch that forms the top cover 11, such that the right haunch 13 and left haunch 12 are the same length and their ends are equidistant from the midline support 14. The midline support 14 has a base 15. The base 15 consists of a right flange 16 and a left flange 17. Each of the flanges 16 and 17 have ends that extend in an upward direction, thus forming a right lip 16A and a left lip 17B. The right lip 16A, right flange 16 and right side of the midline support 14 forms a channel 16B. The left lip 17A, left flange 17 and left side of the midline support 14 form a left channel 17B. In one embodiment, the right lip 16A and left lip 17A can form about a ninety degree angle with their respective flanges 16 and 17. In another embodiment, the right lip 16A and left lip 17A can form greater than a ninety degree angle but less than a one hundred fifty degree angle with their respective flanges 16 and 17. In one embodiment, as shown in FIG. 2, the right lip 16A and left lip 17A form about a one hundred degree angle with their respective flanges 16 and 17. In one embodiment, as shown in FIG. 1A, the midline support 14 extends along the entire length of the connector 10, and the base 15 extends along the entire length of the midline support 14. In another embodiment, as shown in FIG. 1B, the base 25 does not extend along the entire length of the midline support 14, but only along part of the length of the midline support 14. In yet other embodiment, as shown in FIG. 1C, the base can be formed only at the ends of the midline support 14, such that two bases 35 and 45 are formed; one at one end 18 of the connector and the other at the other end 19 of the connector, with no base formed in between the two ends. Alternatively with respect to FIG. 1C (not shown), additional bases can be formed on the midline support 14 between the bases 35 and 45. For example, a base (not shown) can be formed half way in between the bases 35 and 45 on the bottom of the midline support 14. In yet another embodiment, as shown in FIG. 1D, the midline support 24 does not extent along the entire length of the top cover 11, but only along part of the length of the top cover 11. In yet another embodiment, as shown in FIG. 1E, the midline support can be formed only at the ends of the top cover 11, such that there are two midline supports 34 and 44 along with their corresponding bases 55 and 65; one midline support 34 being at one end 18 of the connector 10 and the other midline support 44 being at the other end 19 of the connector 10, with no midline support formed in between the two ends. The two midline supports 23 and 44 extend along the same plane, which is shown by the phantom lines 62. Alternatively with respect to FIG. 1E (not shown), additional midline supports and corresponding bases can be formed between the midline supports 34 and 44 along the same plane 62 as the plane along which midline supports 34 and 44 extend. For example, a midline support and its corresponding base (not shown) can be formed half way in between the midline supports 34 and 44 on the bottom side of the top cover 11. The configurations shown in FIGS. 1B, 1C, 1D, and 1E reduce the amount of raw material needed to form the connector 10, and make the connector 10 lighter. However, these configurations also weaken the connector and make it easier to damage or break the connector with less stress than the embodiment shown in FIG. 1.

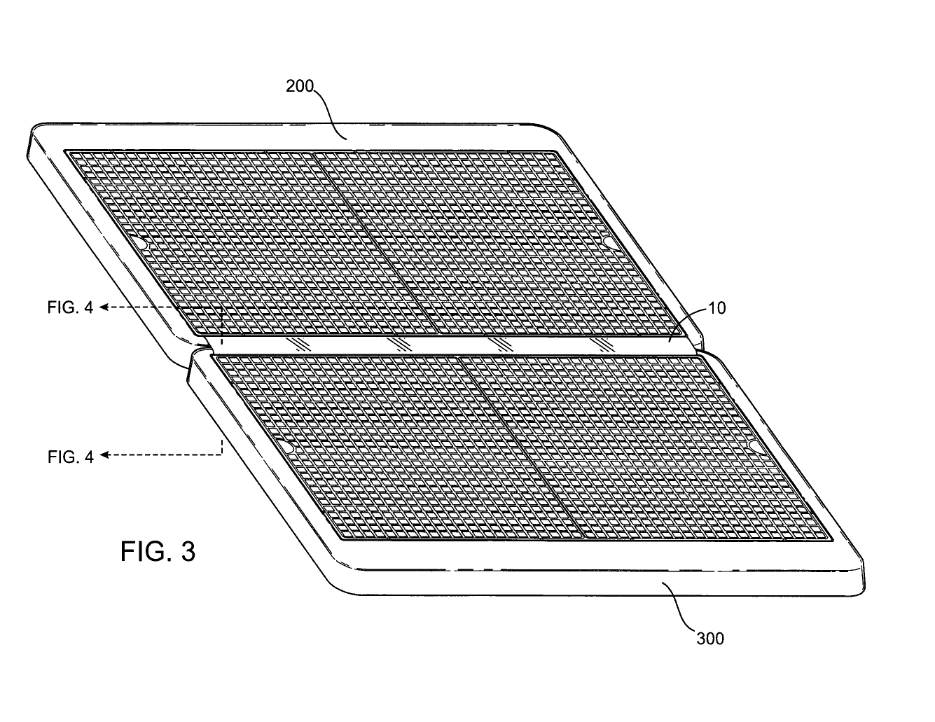

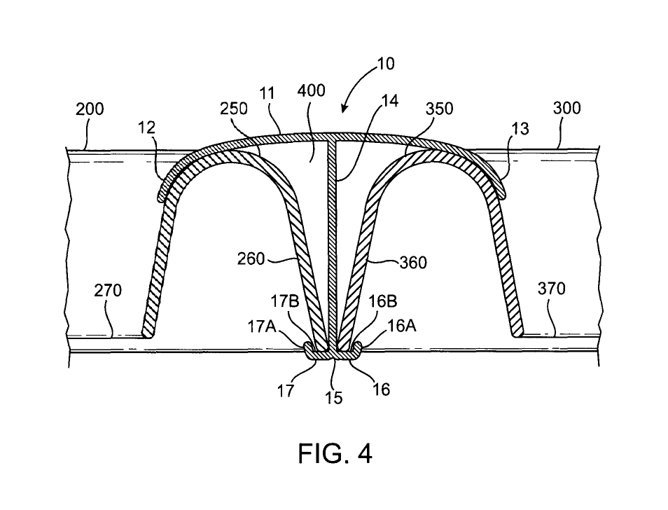

FIGS. 3 and 4 show how a connector 10 can connect two dog potties 200 and 300 along the length of one of the sides of the dog potties. The dog potties 200 and 300 each have corresponding sides 250 and 350 with corresponding side walls 260 and 360 that lead into corresponding receptacles 270 and 370 that retain fluid, such as urine. When the dog potties 200 and 300 are placed next to each other, there is always a gap 400 between them. When a dog or other pet urinates over the gap 400, the urine leaks onto the floor in between the two dog potties rather than flowing into the receptacles 270 and 370 of the dog potties. The top cover 11 of the connector 10 covers the gap 400 and does not permit fluid to flow into the gap 400. Instead, with the connector 10 in place, all fluid will flow down the right haunch 13 and left haunch 12 of the connector and into the receptacles 370 and 270 respectively.

The connector 10 connects the dog potties 200 and 300 in the following manner. The bottom of the side wall 360 of the dog potty on the right fits into the channel 16B. The bottom of the side wall 260 of the dog potty on the left fits into the channel 17B. The right lip 16A prevents the right dog potty 300 from sliding away from the connector 10. The left lip 17A prevents the left dog potty 200 from sliding away from the connector 10. Thus, the connector 10 prevents the two dog potties 200 and 300 from horizontally sliding away from one another. In addition, because the channels 16B and 17B are on the bottom side of the connector and thus underneath the dog potties 200 and 300, it is very difficult for any dog or other pet from devising a way to disconnect the dog potties 200 and 300 from the connector 10. This is made even more difficult, because the haunches 13 and 12 of the top cover 11 arch over the top sides 350 and 250 of the right and left dog potties respectively, thus preventing dog or other pets from somehow lifting the bottom edges of the side walls 360 and 260 up over the lips 16A and 17A. The rounded arches of the haunches 13 and 12 make it easy for a person to use their hands to disconnect the connector 10 from the dog potties 300 and 200, but difficult for a pet to do so. In this manner, the connector 10 keeps the two dog potties horizontally connected to one another.

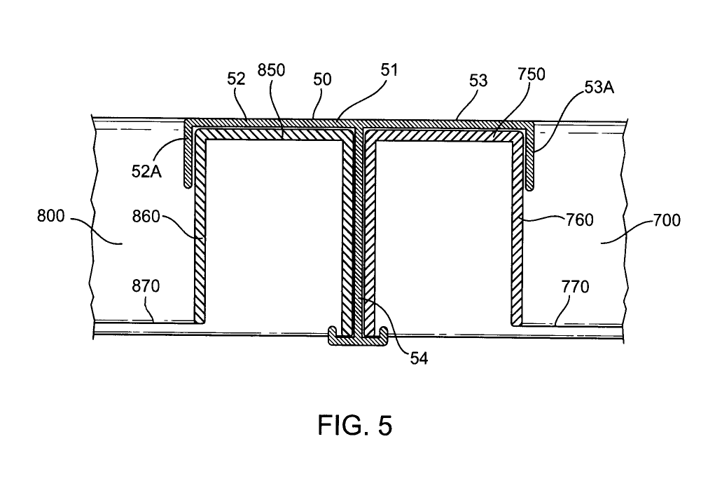

FIG. 5 shows another embodiment of a connector 50 that has a flat top cover 51 with a right flange 53 and a left flange 52. The right flange 53 has a right lip 53A that extends downward, and the left flange 52 has a left lip 52A that extends downward. The configuration shown in FIG. 5 can be used if the side walls of the receptacles, such as dog potties, are flat or squared rather than rounded as shown in FIGS. 3 and 4. The midline support 54 can be identical to any of the midline supports of any of the embodiment shown in FIGS. 1A-1E. As with the dog potties shown in FIG. 4, the dog potties 700 and 800 each have corresponding sides 750 and 850 with corresponding side walls 760 and 860 that lead into corresponding receptacles 870 and 870 that retain fluid, such as urine.

A system that comprises two dog potties and a connector is also described as shown in FIGS. 3, 4 and 5.

While the invention is susceptible to various modifications and alternative forms, specific examples thereof have been shown by way of example in the drawings and are herein described in detail. It should be understood, however, that the invention is not to be limited to the particular forms or methods disclosed, but to the contrary, the invention is to cover all modifications, equivalents, and alternatives falling within the spirit and scope of the appended claims.

We claim:

1. A connector for connecting multiple receptacles comprising:
at least one midline support having a base at its bottom end, wherein the base comprises a left flange and a right flange, wherein the right flange has a lip extending in an upward direction from its end, and the left flange has a lip extending in an upward direction from its end, wherein a right side of the midline support, the right flange and right lip form a right channel at the base, and a left side of the midline support, left flange and left lip for a left channel at the base; and
a top cover at the top of the midline support, wherein the top cover extends laterally in both the left and the right directions from the midline support.

2. The connector of claim 1, wherein the multiple receptacles are dog potties.

3. The connector of claim 1, wherein top cover is formed in the shape of a tudor arch.

4. The connector of claim 1, wherein the top cover is flat and has lips that extend in a downward direction from side ends of the top cover.

5. A dog potty system comprising:
a first dog potty having a perimeter with four walls and a receptacle that catches and retains fluid, wherein each of the walls has a top side and a bottom side;
a second dog potty having a perimeter with four walls and a receptacle that catches and retains fluid, wherein one of the walls of the first dog potty is adjacent one of the walls of the other dog potty; and
a connector that connects the first and second dog potties, the connector having a length that is approximately the same length or shorter than the length of the walls of the dog potties that are adjacent to one another, wherein the connector comprises:
a top cover having a top side and a bottom side, wherein the top cover covers the top sides of the walls of the adjacent dog potties and channels any fluid into the receptacles of the first and second dog potties; and
a midline support that extends downward from the bottom side of the top cover, wherein the midline support has a bottom end that has a first channel and a second channel, wherein the first channel receives the bottom side of the wall of the first dog potty that is adjacent to the wall of the second dog potty, and the second channel receives the bottom side of the wall of the second dog potty that is adjacent to the wall of the first dog potty, such that the two dog potties are horizontally connected to one another by the connector.
